(19) United States
(12) Patent Application Publication
(10) Pub. No.: US 2026/0240074 A1
(43) Pub. Date: Aug. 20, 2026

(54) RESIDUE SPREAD MONITORING

(71) Applicant: AGCO International GmbH, Neuhausen Am Rheinfall (CH)

(72) Inventors: Morten Stigaard LAURSEN, Randers (DK); Martin Peter CHRISTIANSEN, Randers (DK)

(21) Appl. No.: 19/471,260

(22) PCT Filed: Feb. 27, 2024
(86) PCT No.: PCT/IB2024/051848

§ 371 Date: Sep. 30, 2025

(30) Foreign Application Priority Data
Mar. 30, 2023 (GB) 2304751.7

(51) Int. Cl. A01D 41/127; A01D 41/12

(52) U.S. Cl. CPC A01D 41/127; A01D 41/1243

(57) ABSTRACT

Systems and methods for monitoring the distribution of residue material from a spreader tool of an agricultural machine. An event based sensor is used to obtain data indicative of a measure of residue material within an operating region of the spreader tool. From this, a measure of a distribution of residue material associated with the spreader tool is determined and used for controlling operation of one or more operable components associated with the agricultural machine, including the spreader tool itself.

### CROSS-REFERENCE TO RELATED APPLICATIONS

Not applicable.

### FIELD

Embodiments of the present disclosure relate generally to systems and methods for monitoring residue spread from a harvesting machine.

### BACKGROUND

Agricultural harvesters such as combine harvesters, or “combines”, work to cut crop material from a field before separating the grain from the material other than grain (MOG) (referred to interchangeably as “residue”) on board. Generally, the grain is transferred to a grain bin of the combine (where it may be temporarily stored) and the MOG is deposited back onto the field. A second operation may be performed to gather the deposited MOG, or the MOG may be used as a fertiliser for the soil in the field. In either case, it is important for the MOG to be distributed evenly during deposition, in order to ensure an efficient second harvesting operation (e.g. bailing of the MOG) or to ensure effective fertilisation of the soil. When residue is unevenly distributed over a field, not only are exposed areas at risk for erosion, but inconsistencies in soil temperatures and moisture also may cause uneven plant emergence the following year, hurting yield. Ideally, residue should be spread consistently and managed to promote uniform rapid warming and drying in the spring for earlier planting and sufficient seed germination. It is also important not to spread MOG or residue into standing crop adjacent to the machine—i.e. the crop to be harvested on the next pass by the machine-as spreading into standing crop may result in the same area being spread twice causing an unwanted build-up of residue in a given area, again leading to uniformity issues.

To control the distribution of the MOG, known combines include spreader tools which can include deflectors/steering vanes, rotors or the like which are controllable by an operator of the combine. Generally, this is a manual process and the operator must observe the distribution of the MOG during operation and make any necessary adjustments to the spreader tool manually. The distribution of the MOG can be affected by numerous operating conditions, including wind speed, water content of the material, gradient of the field, etc. Accordingly, observing and adjusting the spreader tool manually can be relatively complex and time consuming, especially where the operating conditions vary across the area to be harvested.

In an attempt to address this problem it is known to utilise sensors, e.g. wind direction sensors, ultrasonic sensors, cameras and the like operable to infer or monitor the distribution of the MOG in real time. In some instances, information relating to the observed distribution may be relayed to the operator of the combine (e.g. through a user interface within the operator cab) who may use this information to adjust operation of the spreader tool. In further solutions, control of the spreader tool has been at least partly automated based on data from such sensors, for example by controlling the direction of one or more steering vanes/deflectors in an attempt to account for wind direction. However, such systems are relatively complex and no complete solution has been realised.

It would be advantageous to improve upon these known systems such that the distribution of material from an agricultural machine can be monitored and optionally controlled more effectively and efficiently.

### BRIEF SUMMARY

In an aspect of the invention there is provided a system for monitoring the distribution of residue material from a spreader tool of an agricultural machine, the system comprising: an event based sensor; and one or more controllers, configured to: receive sensor data from the event based sensor indicative of a measure of residue material within an operating region of the spreader tool; determine, from the sensor data, a measure of a distribution of residue material associated with the spreader tool; and output one or more control signals for controlling operation of one or more operable components associated with the agricultural machine in dependence on the determined distribution.

Advantageously, the present disclosure utilises an event based sensor for monitoring a distribution of residue material from a spreader tool of the machine. As discussed herein, an event based sensor may advantageously provide a greater understanding of the material motion when compared with conventional, optical based imaging systems, and may be used in low light conditions for example, where RGB or other camera based systems may be unusable.

When used herein and throughout the term “event based sensor” is intended to include a sensor having multiple individual sensing elements or pixels which are individually triggerable in dependence on one or more variations in the signal output associated with those elements. The one or more variations result from a change in the light incident on said sensing elements, resulting in a change in amplitude in the output signal of those sensing elements. By setting relevant thresholds for said variations, “events” can be triggered in dependence on a given change in incident light on said sensing elements. Such a change may indicate movement in the observed environment, for example. Such sensor types may also be referred to as a neuromorphic camera, a silicon retina or dynamic vision sensor.

In embodiments, the one or more operable components associated with the agricultural machine controllable by the system of the present aspect may include a user interface, e.g. a display means, which may provide information, for example to an operator of the agricultural machine corresponding to the observed residue material distribution. The user interface may comprise a display terminal of the machine, for example. The user interface may comprise a display on a portable user device, e.g. a smartphone, tablet computer, etc. carried by an operator of the machine.

The one or more controllers may be configured to control generation of a graphical representation of the observed distribution. The graphical representation may comprise data from one or more further sensors, e.g. a camera system. The graphical representation may include a representation of the determined distribution. This may include an overlay of a graphic or other generated representation indicative of the determined distribution. This may be provided, for example, as an overlay over on a representation of the working environment of the machine or preferably the operating region of the spreader tool.

The one or more controllers may be configured for controlling the user interface for providing an audible or visual indicator to the operator of the observed residue distribution. For example, the user interface may be operable to or be instructed by the one or more controllers (e.g. through control signals output by the one or more controllers) to display or otherwise indicate an error state when the observed residue distribution differs from a predetermined state (which may be user selected). For example, an operator may select a desired relative distribution of the residue material, e.g. 50/50 split between the left hand side and right hand side of the agricultural machine, and the system may be configured to output an indicator if the observed distribution differs from the desired distribution, or differs from the desired distribution by a predetermined amount.

In further embodiments, the one or more operable components may include component(s) of the machine. For example, the one or more controllers may be operable to control one or more operating parameters of component(s) of the agricultural machine in dependence on the determined residue material distribution. The one or more operating parameters may include operating parameters of the spreader tool.

The spreader tool may include a steering mechanism, and the system may be operable to control one or more operating parameters of the steering mechanism to control the distribution of residue material from the spreader tool. For example, the steering mechanism may include one or more steering vanes or deflectors, and the system may be operable to control a position (e.g. a rotational position) of the steering vane(s) or deflector(s) to control a direction of deflection therefrom.

The steering mechanism may include a first steering unit for controlling the distribution of residue material from the spreader tool in a first direction. The steering mechanism may include a second steering unit for controlling distribution of residue material from the spreader tool in a second direction. The first and second directions may comprise either side of a longitudinal axis of the machine, for example left and right of the machine.

The steering mechanism may include one or more rotors operable to provide a motive force for the residue material through the steering mechanism. For example, the rotor(s) may provide or induce an airflow through the steering mechanism, or may be operable to provide the motive force through contacting the residue material with one or more moveable elements of the rotor—e.g. a rotatable element. The steering mechanism may comprise a first steering unit in the form of a first rotor for controlling movement of residue material through and out of the steering mechanism in generally the first direction and/or a second steering unit in the form of a second rotor for controlling movement of residue material through and out of the steering mechanism in generally the second direction. The system may be operable to control operation of the first and/or second rotor (e.g. a first operating parameter of the spreader tool may relate to the operation of the first rotor and a second operating parameter of the spreader tool may relate to the operation of the second rotor), for example, by controlling a rotational speed of the first and/or second rotor to control distribution of residue material in the first and/or second directions. It will be appreciated that the speed at which the rotors operate may be used to control the extent to which the residue material is distributed from the spreader tool. Accordingly, the system may be operable to control a speed of the first and/or second rotors (e.g. a rotational speed of a rotatable element of the rotor(s). For example, the system may be operable to increase the speed of the first rotor to increase a distance at which the residue material is distributed in the first direction. Likewise, the system may be operable to increase the speed of the second rotor to increase a distance at which the residue material is distributed in the second direction. The system may be operable to decrease the speed of the first and/or second rotor to decrease a distance at which the residue material is distributed in the first/second direction. Where present, the first and/or second rotors may be provided in combination with fixed or moveable steering vane(s)/deflector(s).

The system, and specifically one or more controllers thereof may be operable to control the first steering unit and the second steering unit independently, such that the distribution of residue material from the spreader tool in the first direction and the second direction may be controlled generally independently from one another.

The one or more controllers may be configured to control application of a filter to the output signals from the sensing elements. The filter may be applied to the output signals to remove triggers of individual sensing elements due to background motion. For example, this may be due to the relative movement of the ground causing changes in the light incident on the sensing elements as the machine performs a task, or due to structural vibration and/or component motion during said tasks. Advantageously, applying one or more filters to the analogue output signal from the sensing elements may control the number of individual triggers to be processed by the event based sensor and/or one or more processing units associated therewith.

Additionally or alternatively, the one or more controllers may be configured to apply a filter to the sensor data. Where the processing capabilities of the controllers is high enough it may be possible to receive all triggers and apply said filter(s) digitally to remove or discard unwanted triggers.

The filter may comprise a threshold for an output signal associated with the sensing elements, which may include amplitude or rate of change of amplitude of the output signal. The threshold may be definable and/or be dependent on the agricultural task (to be) performed by the agricultural machine.

The filter may be dependent on a ground speed of the agricultural machine. Advantageously, the relative movement of the ground with respect to the machine, and hence the sensor, may be excluded from the sensor data. The filter may be dependent on an operational speed of the implement, which may include a rotational speed or one or more rotational components of the spreader tool, for example.

The filter may comprise a mask applied to a sensing region of the sensor, e.g. to exclude regions of the sensing region which do not correspond to the spreader tool and/or a material flow associated therewith.

The one or more controllers may be configured to determine one or more flow parameters for the residue material through performance of an optical flow measurement on the received sensor data. The optical flow measurement may provide a flow parameter comprising a measure of a direction, speed or velocity distribution associated with material movement within the sensing region of the sensor. The optical flow measurement may provide a measure of a uniformity of the residue material distribution. The one or more controllers may be operable to identify one or more anomalies in the optical flow measurement. The one or more anomalies may correspond to regions of the material flow exhibiting unusual flow parameters e.g. a different speed or different flow direction when compared with other areas or regions of the material flow, or when compared with an expected flow parameter(s). This may be indicative of an error or fault with the spreader tool.

The one or more controllers may be configured to perform a planar projection of the sensor data. For example, three-dimensional sensor data from the event based sensor may be transformed onto a projection plane. The projection of the data in this way may provide a planar distribution of the observed data points which is more easily interpreted by either an operator of the machine observing the data or indeed for one or more computer vision processes performed thereon—e.g. shape estimation etc.

The one or more controllers may be configured to compile the sensor data from the event based sensor in an event histogram. The histogram may correspond to a measure of a number of activations of individual sensing elements. The histogram may be generated over a time period during operation of the machine. The duration of the time period may be user definable or may be pre-programmed. The one or more controllers may be configured to generate a representation of the event histogram, e.g. for output by an operably coupled user interface in the manner discussed herein. Advantageously, an indication of the overall shape and/or size of the residue material distribution may be inferred from the event histogram.

The one or more controllers may be configured to perform a clustering process of events/triggers of individual sensing elements. The clustering may be a timewise and/or location based clustering to identify triggers at multiple sensing elements which correlate to the same physical observation. For instance, data may be clustered timewise to identify (and optionally track movement of) individual material components (e.g. pieces of straw or other crop material) in the sensor data. Clustering may be applied in dependence on a determined flow velocity of material (e.g. as determined through application of an optical flow measurement of the sensor data) which may be used to indicate regions within the field of view of the sensor where material may be travelling at different speeds to other regions or compared with an expected flow parameter. Regions within the sensing area where no or a lower number of triggers are seen (in areas where they would be expected—e.g. corresponding to a region of the spreader tool) may be indicative of a plugging of material or other fault preventing or reducing material flow in that region.

The one or more controllers may be configured to determine one or more characteristics of the determined residue distribution.

The characteristic(s) may comprise a measure of the width of the residue distribution. The one or more controllers may be configured to compare the measure of the width of the residue material distribution with one or more control parameters, such as the width of the machine or header coupled thereto, for example. The one or more controllers may be configured to control operation of the spreader tool in dependence on this comparison—e.g. to adjust operation thereof to extend or reduce the width of the observed distribution such that it is substantially the same as the width of the machine/header.

The characteristic(s) can comprise a measure of the uniformity of the residue material distribution across its width. This may comprise a comparison of the intensity of the histogram/heatmap across the distribution indicative of how evenly the residue material is spread in the distribution. This may comprise a measure of a distance material is ejected in a given direction compared with an opposite direction—e.g. first and second directions/left-right of the machine.

The one or more characteristics of the residue material distribution may include a shape of the distribution. The one or more characteristics of the residue material distribution may include a skew of the distribution. The skew may comprise a relative measure of an amount of residue material in one or more sub-regions of the sensing region of the imaging sensor. This may include a relative measure of an amount of residue material left or right of a centreline located substantially centrally along a longitudinal axis of the machine. The one or more characteristics of the residue material distribution may include a distance at which the residue material is spread. This may include a distance from the spreader tool at which the residue material is spread. The one or more characteristics of the residue material distribution may include a maximum lateral extent of residue material spread by the spreader tool. The one or more characteristics of the residue material distribution may include a density of material across the residue material distribution. Such characteristic may be indicative of an issue with component calibration, such as a directionality of the spreader tool, for example, and/or environmental conditions including drift due to the wind direction, for example.

The system may include one or more additional sensors. Data from the one or more additional sensors may be useable by the one or more controllers for positioning of the spreader tool and/or material flow associated therewith within the sensor data from the event based sensor, for example. The one or more additional sensors may comprise a camera, LIDAR unit, RADAR unit or the like.

The event based sensor may be mounted or be mountable on the machine. For example, the sensor may be mounted or be mountable on the rear of the machine, or on an unloading auger of the machine, for example.

The one or more controllers may collectively comprise an input (e.g. an electronic input) for receiving one or more input signals. The one or more input signals may comprise the sensor data from the event based sensor. The one or more controllers may collectively comprise one or more processors (e.g. electronic processors) operable to execute computer readable instructions for controlling operation of the system, for example, to determine the residue distribution. The one or more processors may be operable to generate one or more control signals for controlling operation of the one or more operational components. The one or more controllers may collectively comprise an output (e.g. an electronic output) for outputting the one or more control signals.

A further aspect of the invention provides an agricultural machine comprising the system of any aspect described herein. The agricultural machine may comprise a harvesting machine, such as a combine or forage harvester, for example.

A further aspect of the invention provides a method of monitoring the distribution of residue material from a spreader tool of an agricultural machine, comprising: receiving sensor data from an event based sensor indicative of a measure of residue material within an operating region of the spreader tool; determining, from the sensor data, a measure of a distribution of residue material associated with the spreader tool; and controlling operation of one or more operable components associated with the agricultural machine in dependence on the determined distribution.

The method may comprise performing any one or more of the functionalities of the control system described hereinabove.

A further aspect of the invention provides computer software comprising computer readable instructions which, when executed by one or more electronic processors, causes performance of a method in accordance with any aspect described herein.

A yet further aspect of the invention provides a computer readable medium having the computer software of the preceding aspect of the invention stored thereon.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a schematic side cross-sectional view of an agricultural harvester embodying aspects of the present disclosure;

FIG. 2 is a schematic view of an embodiment of a system of the present disclosure;

FIG. 3 illustrates sensor data obtained by a sensing arrangement forming part of aspects of the present disclosure; and

FIG. 4 is an image of residue material obtained utilising a camera illustrating the operational use of embodiments discussed herein.

### DETAILED DESCRIPTION

The present disclosure relates to systems and methods for monitoring the distribution of residue material from a spreader tool 22 of an agricultural machine, here a harvester 10. An event based sensor 30 is utilised to obtained sensor data which is indicative of a measure of residue material within an operating region of the spreader tool 22. Controller(s) 102 is configured to analyse the sensor data to determine a measure of a distribution of the residue material. Operation of one or more operable components associated with the harvester 10 (e.g. a user interface 32 or components of the spreader tool 22, for instance) can be controlled based on the distribution, in the manner discussed herein.

### Harvester

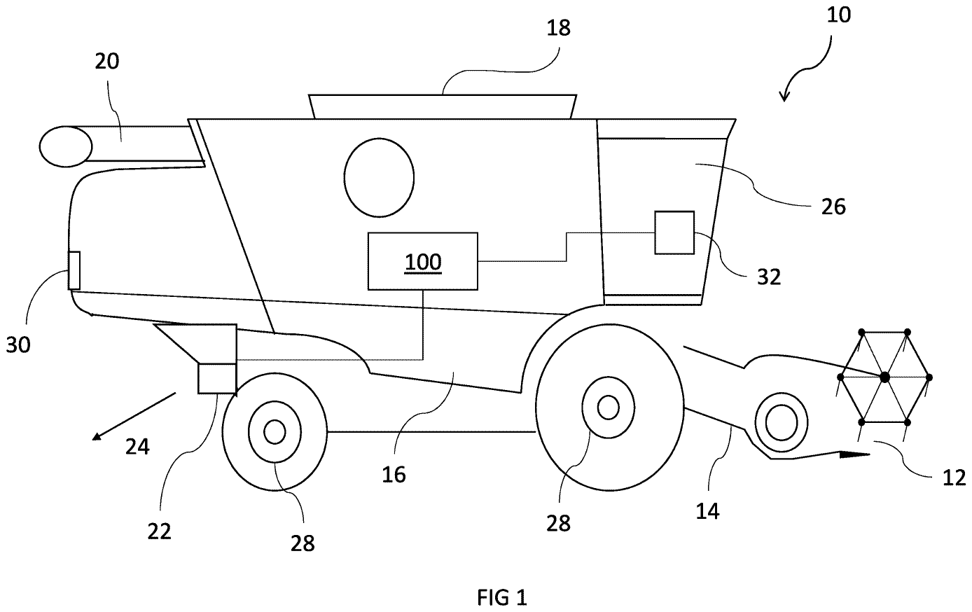

With reference to FIG. 1, an agricultural machine in the form of a harvester 10 is shown which embodies aspects of the present disclosure.

The harvester 10 is coupled to a header 12 which is operable, in use, to cut and gather a strip of crop material as the harvester 10 is driven across a field/area to be harvested during a harvesting operation. A conveyor section 14 conveys the cut crop material from the header 12 into a crop processing apparatus 16 operable to separate grain and non-grain (i.e. material other than grain (MOG) or residue material (used interchangeably herein)) as will be appreciated. It is noted here that apparatus for separating grain and non-grain material are well-known in the art and the present invention is not limited in this sense. The skilled person will appreciate that numerous different configurations for the crop processing apparatus may be used as appropriate. Clean grain separated from the cut crop material is collected in a grain bin 18, which may be periodically emptied, e.g. into a collection vehicle, storage container, etc. utilising unloading auger 20. The remaining non-grain material (MOG)/residue material is separately moved to a spreader tool 22 which is operable in use to eject the non-grain material or MOG from the rear of the harvester 10 and onto the ground. In FIG. 1, this is represented by arrow 24 which illustrates the MOG being ejected rearwards from the harvester 10. It will be appreciated that in some embodiments the harvester 10 may also include a chopper tool 11 positioned, for example, between the crop processing apparatus 16 and the spreader tool 22 and operable, in use, to cut the residue material before it is spread by the spreader tool 22.

The harvester 10 also typically includes, amongst other features, an operator cab 26, wheels 28, engine (not shown) and a user interface in the form of a display terminal 32 provided within the operator cab 26.

### Event Based Sensor

As will be discussed in detail herein, the harvester 10 additionally includes a sensor in the form of an event based sensor 30. The sensor 30 is mounted to a rear of the harvester 10 in the illustrated embodiment, and has a field of view which encompasses an operating region of the spreader tool 22, specifically here the region of the working environment directly behind the harvester 10 into which residue material is spread by the spreader tool 22. Event based sensor 30 is used, by a control system 101 of the harvester, to determine a distribution of residue material associated with the spreader tool 22 in the manner discussed herein.

Event based sensor 30 has multiple individual sensing elements (pixels) which are individually triggerable in dependence on one or more variations in the signal output associated with those elements. The one or more variations result from a change in the light incident on said sensing elements, resulting in a change in amplitude in the output signal of those sensing elements. By setting relevant thresholds for said variations, “events” can be triggered in dependence on a given change in incident light on said sensing elements. The variations can be used as an indication of movement in the observed environment, for example, by monitoring successive triggers of adjacent sensing elements, and inferring movement in the observed scene based thereon. In further arrangements the overall sensor output for a given time period may be used—e.g. forming of a histogram or heat map of triggers—to obtain a measure of an overview of a given process—e.g. shape/size of flowpath or material distribution, etc.

Operation of the event based sensor 30 may be controlled based on the given scenario. For instance a filter may be applied to the sensing elements to control at what magnitude of change/variation said sensing elements are triggered. This may be utilised to remove background events from the data. For instance, in the presently illustrated embodiment using the sensor 30 on the harvester 10 during a harvesting operation, motion of the ground with respect to the harvester 10 may otherwise trigger the sensing elements. Accordingly, a filter can be applied based on the ground speed of the harvester 10 to reduce or eliminate false triggers thereof. In alternative arrangements, the operational speed of the components of the harvester 10, e.g. a rotational speed of elements of the spreader tool 22, may be used to determine the filter to be applied to the sensor data to remove cyclical or repetitive motion from the scene e.g. in order to identify anomalies or changes in that motion indicative of an operational issue.

In yet further use cases, a clustering process may be applied to the sensor data. This clustering may be a timewise and/or location based clustering to identify triggers at multiple sensing elements which correlate to the same physical observation. For instance, data may be clustered timewise to identify (and optionally track movement of) individual material components (e.g. pieces of straw or other crop material) in the sensor data. Clustering may be applied in dependence on a determined flow velocity of material (e.g. as determined through application of an optical flow measurement of the sensor data) which may be used to indicate regions within the field of view of the sensor where material may be travelling at different speeds to other regions or compared with an expected flow parameter. Regions within the sensing area where no triggers are seen (in areas where they would be expected) may be indicative of a plugging of material or other fault preventing material flow in that region.

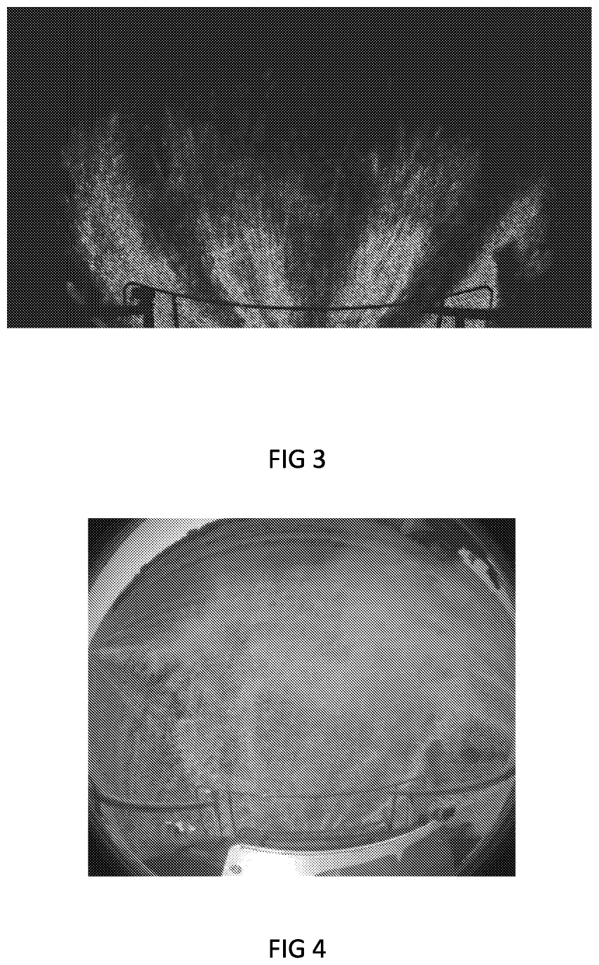

FIG. 3 illustrates a representation of sensor data obtained during operation of the harvester 10. Here, “triggered” sensing elements of the event based sensor 30 are shown indicative of movement in the region of the environment corresponding to the relevant pixel in the displayed sensor data. FIG. 4 illustrates the same scene utilising a camera based system with residue material shown being spread behind the rear of a harvester. As shown, through suitable processing of the sensor data via filters and the like, only those triggers in response to movement of residue material within the observed region is present in the generated representation. This removes background noise/triggers from the data enabling a better representation of the residue distribution.

### System

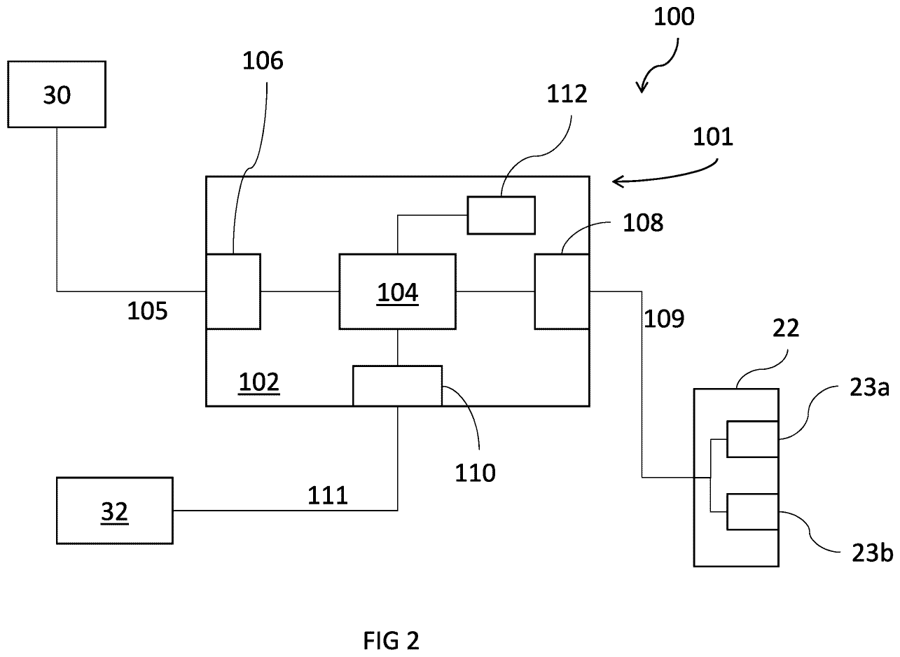

FIG. 2 illustrates system 101 further. As shown, the system incorporates a control system 100 here having a single controller 102. The controller 102 includes an electronic processor 104, an electronic input 106 and electronic outputs 108, 110. The processor 104 is operable to access a memory 112 of the controller 102 and execute instructions stored therein to perform the steps and functionality of the present invention, for example to output control signals 109 via the output 108 for controlling operation of the spreader tool 22, and more specifically first and second steering units of the spreader tool 22, here in the form of a first rotor 23a and a second rotor 23b, for controlling the distribution of residue material ejected from the spreader tool 22, or for controlling the display terminal 32, for example to provide an image to an operator of the harvester 10 illustrative of the observed residue material distribution.

The processor 104 is operable to receive sensor data via input 106 which, in the illustrated embodiment, takes the form of input signals 105 received from the event based sensor 30. As described in detail herein, the event based sensor 30 has a sensing region rearward of the harvester 10, with the sensor data received from the sensor 30 being indicative of a measure of residue material within the sensing region. Using this information, the processor 104 is operable to determine a residue material distribution in the manner described herein. Specifically, the processor 104 is analyse the sensor data received from the event based sensor 30 to determine the residue distribution. In embodiments, this includes obtaining a histogram over time representing the number of triggers of given sensing elements of the event based sensor 30. By ensuring the time period for the histogram is sufficiently long, a clearer picture of the overall shape of the distribution can be determined from the sensor data, as compared with a single snapshot taken with the event sensor 30 or indeed other image based (e.g. camera based) systems.

In the embodiment shown in FIG. 2, the output 110 is operably coupled to the display terminal 32 of the harvester 10. Here, the control system 101 is operable to control operation of the display terminal 32, e.g. through output of control signals 111 in order to display operational data to an operator of the harvester 10 relating to the operation of the control system 101. Specifically, the control system 101 may be operable to control the display terminal 32 to display to the operator a graphical representation of the residue material distribution from the spreader tool 22 as determined by processor 104, sensor data from the event based sensor 30, image data obtained from a camera on the harvester 10, or other useful information. In some variants, the display terminal 32 may also be operable to receive a user input from the operator, and in such instances the output 110 may act as an input for receiving that user input at the processor 104. The user input may relate to a requested or desired distribution of residue material, for example, made by the operator of the harvester 10.

The system 100 shown in FIG. 2 also includes the spreader tool 22 being operably connected to the controller 102 via output 108. Here, the control system 101 is configured to control operation of the spreader tool 22, and specifically operational components thereof-first and second rotor units 23a, 23b in dependence on the determined material distribution.

Firstly, the processor 104 is configured to determine one or more characteristics of the residue material distribution, determined in the manner discussed herein. For instance, the processor 104 can be configured to identify a boundary of residue material, i.e. the greatest extent in any given direction that the residue material is being spread by the spreader tool 22. For example, the processor 104 may be configured to analyse the sensor data, e.g. the heatmap/distribution determined therefrom to identify for a step or other variation in the data representing an interface between residue material and the background. This may include determining a maximum lateral distance at which the material is being ejected from the spreader tool 22, e.g. in a first or second direction (left or right of the harvester 10). This may be particularly important in terms of determining whether the material is being spread into adjacent standing crop. The processor 104 here is configured to output control signals 109 via electronic output 108 to spreader tool 22, and specifically to first and second rotors 23a, 23b to adjust operation thereof, e.g. to reduce the speed of the rotor 23a, 23b associated with the side of the harvester 10 proximal to the standing crop, or in some instances adjust the orientation of one or more steering vanes (not shown) where it is determined that the residue material is being spread into the standing crop to reduce the maximum lateral distance at which the residue material is being spread by the spreader tool 22 in that direction. The opposite use case may also apply, where the residue is not being spread up to the adjacent standing crop, and in such instances output control signals 109 via electronic output 108 to spreader tool 22, and specifically to first and second rotors 23a, 23b to adjust operation thereof, e.g. to increase the speed of the rotor 23a, 23b associated with the side of the harvester 10 proximal to the standing crop, or in some instances adjust the orientation of one or more steering vanes.

Processor 104 can additionally or alternatively be configured to determine whether the residue material distribution is skewed left or right, or is substantially uniform. Any skewness in the distribution would be shown as a higher density of data points, or greater values for different data points/cluster of points in the heatmap on one side of a central axis (e.g. a central longitudinal axis of the harvester 10 running through the middle of the spreader tool 22) compared with the other. For example, if a higher volume of material is determined on the left side of the harvester 10, then it is possible to infer that the distribution of residue material is skewed to the left and appropriate action may be taken based thereon. For example, control signals 109 can be output via electronic output 108 to spreader tool 22, and specifically to first and second rotors 23a, 23b to adjust operation thereof, e.g. to reduce the speed of the left rotor 23a and/or increase the speed of the right rotor 23b, or in some instances adjust the orientation of one or more steering vanes (not shown) to reduce the skewedness of the residue distribution profile-essentially by increasing the volume of material ejected generally in the right direction and/or reduce the volume of material ejected generally in the left direction.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

What is claimed is:

1. A system for monitoring the distribution of residue material from a spreader tool of an agricultural machine, the system comprising:
an event based sensor; and
one or more controllers, configured to:
receive sensor data from the event based sensor indicative of a measure of residue material within an operating region of the spreader tool;
determine, from the sensor data, a measure of a distribution of residue material associated with the spreader tool; and
output one or more control signals for controlling operation of one or more operable components associated with the agricultural machine in dependence on the determined distribution.

2. A system as claimed in claim 1, wherein the one or more controllers are configured to control application of a filter to the output signals from individual sensing elements of the event based sensor to remove triggers thereof due to background motion.

3. A system as claimed in claim 2, wherein the filter is dependent on a ground speed of the agricultural machine.

4. A system of claim 1, wherein the one or more controllers are configured to determine one or more flow parameters for the residue material through performance of an optical flow measurement on the received sensor data.

5. A system of claim 1, wherein the one or more controllers are configured to compile the sensor data from the event based sensor in an event histogram corresponding to a measure of a number of activations of individual sensing elements of the event based sensor.

6. A system of claim 1, wherein the one or more controllers are configured to perform a clustering process of events or triggers of individual sensing elements, the clustering being a timewise and/or location based clustering to identify triggers at multiple sensing elements which correlate to the same physical observation.

7. A system of claim 1, wherein the one or more controllers are configured to determine one or more characteristics of the determined residue distribution, the characteristic(s) comprising any one or more of a shape or size of the residue distribution.

8. A system of claim 7, wherein the characteristic(s) comprise a measure of the width of the residue distribution, and wherein the one or more controllers are configured to compare the measure of the width of the residue material distribution with one or more control parameters including the width of the machine or a header coupled thereto.

9. A system of claim 7, wherein the characteristic(s) comprise a measure of the uniformity of the residue material distribution across its width.

10. A system of claim 1, wherein the one or more operable components associated with the agricultural machine controllable by the system of the present aspect include a user interface, and wherein the one or more controllers are configured to control generation of a graphical representation of the observed distribution via the user interface.

11. A system of claim 10, wherein the graphical representation includes a representation of the determined distribution in the form of an overlay of a graphic or other generated representation indicative of the determined distribution provided over on a representation of the working environment of the machine or the operating region of the spreader tool.

12. A system of claim 1, wherein the one or more operable components include component(s) of the machine; and wherein the one or more controllers are operable to control one or more operating parameters of component(s) of the agricultural machine in dependence on the determined residue material distribution.

13. A system of claim 12, wherein the one or more operating parameters include one or more operating parameters of the spreader tool.

14. A system of claim 13, wherein the spreader tool includes a steering mechanism, and the one or more controllers are operable to control one or more operating parameters of the steering mechanism to control the distribution of residue material from the spreader tool in dependence on the determined material distribution.

15. An agricultural machine comprising the system of claim 1.

16. A method of monitoring the distribution of residue material from a spreader tool of an agricultural machine, comprising:
receiving sensor data from an event based sensor indicative of a measure of residue material within an operating region of the spreader tool;
determining, from the sensor data, a measure of a distribution of residue material associated with the spreader tool; and
controlling operation of one or more operable components associated with the agricultural machine in dependence on the determined distribution.
